(19) United States
(12) Patent Application Publication
(10) Pub. No.: US 2006/0024438 A1
(43) Pub. Date: Feb. 2, 2006

(54) Radially layered nanocables and method of fabrication

(75) Inventors: Jie-Ren Ku, Davis, CA (US); Pieter Stroeve, Davis, CA (US); Ruxandra Vidu, Citrus Heights, CA (US); Raisa Talroze, Novato, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: THE REGENTS OF THE UNIVERSITY OF CALIFORNIA, a California corporation, Oakland, CA (US)

(21) Appl. No.: 10/900,978

(22) Filed: Jul. 27, 2004

(51) Int. Cl. B05D 7/22

(52) U.S. Cl. 427/237; 427/593; 427/58; 428/398

(57) ABSTRACT

Radially layered nanocables are fabricated by first forming nanotubes within tubular passages of nano-sized diameter, then depositing a material dissimilar to that of the nanotubes over the surface(s) of the nanotubes by underpotential electrochemical deposition. Both hollow cables and cables with solid cores can be manufactured in this manner. The tubular passages reside in membranes or wafers that can be removed from the nanocables either before or after the second material is deposited, or in some applications, the nanocables are useful when still embedded in the membranes or wafers.

### BACKGROUND OF THE INVENTION

1. Field of the Invention

This invention resides in the field of junctions between dissimilar materials and means for detecting, measuring, or otherwise exploiting electrical effects created by such junctions.

2. Description of the Prior Art

The energy discontinuity that occurs at the junctions of dissimilar materials has found a wide range of uses and led to many different devices utilizing such junctions. The semiconductor, device physics, microelectronics, and biotechnology industries have all found ways to utilize differential energy junctions and to tailor them for specific and widely diverse uses. Junctions between metals and semiconductors or between different semiconductors, for example, appear in devices ranging from biosensors to photovoltaic cells and microelectromechanical systems (MEMS).

Any of these systems can suffer limitations based on size or physical dimensions, limiting their accessible surface area, resistance to current flow or voltage changes, and response time.

### SUMMARY OF THE INVENTION

The present invention resides in nanocables that contain, at least in part, a core and shell, or nested shells, of dissimilar materials, formed in tubular passages whose diameters are of nano-sized dimensions. The contacting surfaces of the dissimilar materials serve as junctions that provide the same functions as those of the differential energy junctions of the prior art but with the advantages that are typically afforded by a smaller scale, and particularly the nano-scale. In nanocables, these advantages include high capacity, high sensitivity, and high-speed signal generation and transmission. To form the nanocables, nanotubes of a first material are formed within the tubular passages, and then, either while the nanotubes are within the passages or after the nanotubes have been removed from the passages, the second material is electrochemically deposited over the walls of the nanotubes by radial growth using underpotential deposition. The extent of radial growth can be limited to control the thickness of the deposited layer, or, when the radial growth is inward toward the axis of the nanotube, the radial growth can be continued until the deposited solid fills the interior or the nanotube to form a continuous core. In various alternative configurations and modes of growth, the interior of each nanotube can thus be filled with a core material, or the second material can be deposited over either the interior surface of the nanotube wall, the exterior surface, or both. Still further, a succession of layers of different materials, alternating materials, or different thicknesses of materials can be deposited to form nested cylinder nanocables. The tubular passages can be open at both ends to form elongated through-passages in a template or nanoporous membrane, or closed at one end to form relatively deep dead-end pores or wells of nano-sized diameters.

The term “nanocable” as used herein denotes any elongate body whose width or diameter is of nanoscale size, and which is fabricated with dissimilar materials of construction that are arranged radially relative to each other, either as a core rod or wire that is laterally enveloped by one or more layers of material(s), or as two or more nested cylinders with a hollow center, such that adjacent layers in either case are of dissimilar materials. The functional element of the nanocable in each case is the contacting surface(s) between the two (or more) materials. Preferred nanocables in accordance with this invention are those that contain a solid core rather than being hollow.

The use of underpotential deposition to achieve radial growth results in layers of highly controlled thickness, uniformity, and reproducibility, with adjacent layers in full contact to form secure and continuous junctions. The nano-sized diameters of the cables and the fact that a large number of the cables can be concentrated within a limited space permit the manufacture of devices with junctions of extremely high surface area, where high concentrations of energy differentials can be measured or drawn from in very limited spaces. In sensor-type applications, the high junction area per unit volume provides the sensor with a sensitivity to concentrations that might be too low to detect by conventional methods, and with a response time that is fast enough to detect rapid transitory changes. In actuator systems, the nanoscale size likewise offers high sensitivity and rapid response. In signal transmission and energy conversion systems, the nanoscale size reduces energy losses without sacrificing capacity and, when light energy is involved, provides a large surface area for incoming light in a nano-array format. The invention can also be used to form radial transistors, each transistor including a source region, a gate region, and a sink region, all as nested cylinders of nano-sized diameter and wall thickness. These transistors can be grown inside a silicon wafer, thereby providing a chip with a high density of transistors due to their internal placement in the wafer, their orientation normal to the chip surface, and their nano-scale dimensions.

These and other features, embodiments, applications, and advantages of the invention will be better understood from the description that follows.

### DETAILED DESCRIPTION OF THE INVENTION AND PREFERRED EMBODIMENTS

The tubular passages used in the practice of this invention reside in forms that serve as molds or substrates for the various deposition processes. In general, these forms are nanoporous solids, such as membranes, wafers, or templates, and are manufactured and sold for a variety of uses, including gas separations, shape-selective catalysis, membrane reactors, electronics applications, and nanoelectromechanical systems. In certain membranes and wafers, the pores are through-passages open at both ends, while in others the pores are dead-end pores. One of the uses for which nanoporous membranes are disclosed is in the fabrication of nanowires and nanotubes. One method for forming nanoporous membranes is the track-etch method, in which a non-porous sheet, typically formed of a polymer such as a polycarbonate or a polyester, is bombarded with nuclear fission fragments to create damage tracks which are then etched into pores. The result is a sheet with cylindrical pores of random distribution and uniform diameter. Nanoporous membranes manufactured by this method are available from Nucleopore Corporation (Pleasanton, Calif., USA) and Poretics Corporation (Livermore, Calif., USA), and the process itself is described by Hulteen, J. C. et al., “A general template-based method for the preparation of nanomaterials,” J. Mater. Chem., 7(7), 1075-1087 (1997). Nanoporous membranes can also be formed from an aluminum sheet or foil by anodization in an acidic electrolyte. This method is described by Routkevich, D., et al., “Electrochemical fabrication of CdS nanowire arrays in porous anodic aluminum oxide templates,” J. Phys. Chem. 100: 14037-14047 (1996), and in U.S. Pat. No. 6,705,152 B2 (Routkevich, D., et al., Mar. 16, 2004, assigned to Nanoproducts Corporation). Nanoporous mica membranes are also known, as described in Sun, L., et al., “Fabrication of nanoporous single crystal mica templates for electrochemical deposition of nanowire arrays,” J. Mat. Sci. 35, 1079 (2000). In the practice of the present invention, polymeric track-etched membranes, particular those of polycarbonate, are particularly preferred. Nanoporous silica membranes are formed by etching silicon wafers through masks that are formed by self-organizing diblock copolymer thin films. The templates are formed, for example, from a block copolymer system consisting of polystyrene (PS) and poly(methyl-methacrylate) (PMMA), spin cast over a silicon wafer. The copolymer system is then allowed to separate spontaneously into a hexagonal lattice of nano-scale PMMA cylinders in a matrix of PS, the dimensions of the cylinders depending on the molecular weights of the polymers. By sequentially etching the cylinders to form the mask and then the silicon through the mask, the nano-scale pores are formed in the silicon. Descriptions of nanoporous silica membranes and how they are formed are found in Thurn-Albrecht, J., et al., “Ultrahigh-Density Nanowire Arrays Grown in Self-Assembled Diblock Copolymer Templates,” Science 290: 2126-2129 (15 Dec. 2000); Guarini, K. W., et al., “Nanoscale patterning using self-assembled polymers for semiconductor applications,” J. Vac. Sci. Technol. B 19(6): 2784-2788 (November/December 2001); and Guarini, K. W., et al., “Process integration of self-assembled polymer templates into silicon nanofabrication,” J. Vac. Sci. Technol. B 20(6): 2788-2792 (November/December 2002).

In this specification and the appended claims, the prefix “nano” and the various terms in which it is used, including “nanoscale,” “nanotube,” and “nanoporous” refer to a dimension that is substantially less than one micron. Preferred nanoporous membranes are those with pore diameters of about 200 nm or less, more preferred are those with pore diameters within the range of from about 5 nm to about 200 nm, and even more preferred are those with pore diameters within the range of from about 30 nm to about 150 nm. The thickness of the membrane may vary widely, although best results in most cases will be obtained with membrane thicknesses within the range of from about 3 μm to about 3,000 μm, and preferably from about 10 μm to about 1,000 μm. The density of the pores in the membrane is subject to even greater variation. Densities can range from about 10³ to about 10¹¹ pores per square centimeter, although densities of from about 10⁶ to 10⁹ pores per square centimeter are most common.

The dissimilar materials of the nanocables, i.e., the material from which the nanotube is formed and the material or materials that are deposited over the nanotube, can be any dissimilar materials in which the junction between adjacent materials forms an energy barrier or differential that can be manipulated, transformed, or measured to beneficial effect. Pairs of materials can thus include two electrical conductors, two semiconductors, two electrical insulators, or any combination, such as an electrical conductor and a semiconductor, an electrical insulator and a semiconductor, and an electrical insulator and an electrical conductor. One of the most useful pairs of materials is that of an electrically conductive metal and a semiconductor, while the semiconductor itself can be a metal or a multimetallic or other metal-containing compound. In certain applications, the nanotube is preferably a metal that is substantially less reactive toward other elements than the material that is deposited radially over the metal. Examples of such low-reactivity metals are copper, silver, gold, nickel, palladium, and platinum, and of these, gold and silver are preferred. Examples of semiconductor metals, compounds, and alloys are sulfur, selenium, tellurium, polonium, phosphorus, arsenic, antimony, bismuth, carbon, silicon, germanium, tin, lead, aluminum, gallium, indium, thallium, zinc, cadmium, mercury, and their compounds and alloys, including cadmium telluride, zinc sulfide, cadmium selenide, and cadmium sulfide. Of these, tellurium, cadmium; cadmium telluride, zinc sulfide, and cadmium sulfide are preferred.

Further variety in the selection of materials and tuning of the energy differential at the junction between the dissimilar materials can be achieved by doping the materials with other elements. Doping methods and the effects of doping are well known in the semiconductor industry. Examples of n-type dopants are silicon, sulfur, selenium, and tellurium, and examples of p-type dopants are beryllium, magnesium, zinc, carbon, and cadmium.

Formation of the nanotubes inside the tubular passages can be accomplished by any of a variety of methods. Examples are electrochemical deposition, electroless deposition, sol-gel deposition, and chemical vapor deposition, all of which are well known. A preferred method is electroless deposition, achieved by reducing a metal from solution onto the inner surfaces of the passages. Electroless deposition can be enhanced by first applying a sensitizer such as Sn⁺² ion to the wall surface. The sensitizer forms a complex with amines, carbonyl groups, or hydroxy groups on the wall surface. The sensitized surface can then be activated by exposure to Ag⁺ ion which results in the deposition of nanoscopic silver particles on the surface. The surface, i.e. the entire form in which the passages reside, is then immersed in a plating bath of the desired metal and a reducing agent. The immersion is continued only long enough to deposit a thin layer of the metal on the wall of the passage, and not enough to fill the passage. The thickness of the layer and hence the inside diameter of the nanotube are readily controlled by limiting the immersion time of the form in the plating bath. The final thickness is a matter of choice whose selection will be dictated by the dimensions sought for the final nanocable. While the optimal thickness will vary with each application or final use of the nanocable, best results will be obtained in most cases with a wall thickness of from about 10 nm to about 150 nm, and preferably from about 30 nm to about 50 mm.

The terms “radial growth” and “radial” in general, as used in this specification, refer to growth in a direction normal to the wall surface. With underpotential deposition, a monatomic or monomolecular layer is first deposited over the entire wall surface, and the layer then thickens by growing in the direction normal to, i.e., away from, the wall in a substantially uniform manner over the wall surface. Deposition can then be halted after a selected interval to leave a layer of substantially uniform thickness over the wall, the thickness depending on the length of the interval. The term “underpotential deposition” is used herein as it is in the art in general, where it is commonly applied to the deposition of a second metal (or metal-containing compound) over a first metal that is more noble, i.e., less reactive toward other elements, than the second. The deposition is termed “underpotential” since the potential that is used is in a region that is positive of the reversible Nernst potential of the first metal. The attraction between the two metals during underpotential deposition is stronger than the attraction between atoms of the second metal, causing the second metal to preferentially spread over the surface before bulk deposition can occur.

The optimal potential for any given pair of materials will vary with the materials themselves and with the desired thickness of the layer, and can be readily determined by routine experimentation. In most cases, useful results will be obtained using a negative potential whose value is equal to or less than two-thirds, or preferably equal to or less than one-third, the potential at which bulk deposition of the second material occurs.

Underpotential deposition can also be used in the practice of this invention to achieve co-deposition of two or more elements to form a compound, alloy, or any multi-element layer at the nanotube surface. In one form of underpotential deposition, known as electrochemical atomic layer epitaxy (ECALE), atomic layers of two elements are deposited in alternating manner from a common solution by switching between different potentials selected to favor one element over the other or between different solutions, one for each element. In further alternatives, the underpotential deposition of one element can be succeeded by bulk electrochemical deposition, or other types of deposition, of one or more other elements.

As noted above, radial deposition can occur either inwardly toward the axis of the nanotube, thereby forming a core within the nanotube shell, or outwardly away from the axis of the nanotube, thereby applying outer layers, or both simultaneously or in succession. When forming the core alone, the second material can be deposited while the nanocable still inside the tubular passage. The finished nanocable can then be recovered by removing the form. When depositing materials on the outer surface of the nanotube, the form can be removed first, prior to the deposition. Deposition on the outer surface of the nanotube can also be achieved while the nanotube is still inside the form, by etching, dissolving, or removing sacrificial material between the nanotube and the form. The layer of sacrificial material can be a binding material used during the formation of the nanotube or any other layer that can be removed without also removing the nanotube.

In certain embodiments of the invention, the nanocables will find use while still embedded in the form or substrate in which the nanotubes of the initial stage of the process were formed. One example are transistors formed on a silicon wafer. The nanocables will function as transistors while still embedded in the wafer. In various other embodiments, the nanocables, or in some cases the nanotubes prior to the deposition of the second and any subsequent layers, are removed from the form or substrate for use on their own.

In embodiments of the invention in which the form or substrate is removed at some stage in the manufacture of the nanocables, the form or substrate can be removed by methods known in the art, without harm to the nanotube or any layers deposited on the nanotube. The form can be dissolved in an appropriate solvent or dissolving agent, the choice depending on the material from which the form is made as well as the material of the nanotube and other layers present. Polymeric membranes, for example, are readily dissolved by immersion in an organic solvent, one example of which is methylene chloride. Anodic aluminum oxide membranes can be dissolved in 1.0M NaOH or other dilute base.

Electrical connections to the nanocables can be achieved by packing the cables onto silicon wafers or other substrates whose surfaces contain imprinted circuits. This can be done while the nanocables are still within the membranes, using a suitable electrically conductive adhesive such as two-sided copper tape to secure one side of the membrane to the silicon, then dissolving the membrane by any of the methods listed above.

Nanocables in accordance with the present invention are useful for a variety of functions. One of these is the sensing and detection of chemical or biological analytes in a fluid medium. When a charged analyte contacts the outer surface of a nanocable, the charge causes a shift in the energy barrier at the junction. The resulting change in voltage serves as an indication of the presence of the charged species, and the magnitude of the voltage can serve as an indication of the quantity or concentration of the analyte. The dissimilar materials in the nanocable can be selected specifically for certain analytes, and doping with conventional dopants will be particularly useful in adjusting the properties of the materials. Multiple analytes can be detected simultaneously by using a combination of nanocables fabricated from different pairs of materials or by doping to different degrees or with different dopants. An advantage to the use of nanocables as biosensors or chemical sensors is the high surface area which leads to the ability to sense low concentrations of the analytes.

Nanocables in accordance with this invention also find use as photovoltaic devices in solar cells. The conventional thin-film photovoltaic device suffers the limitations of a limited surface area, the need for light to penetrate a relatively thick p-region before reaching the active area of the cell, and the presence of electrodes covering portions of the face of the cell and thereby limiting the surface area accessible to the impinging light. These limitations are overcome by nanocables, by virtue of the greater amount of usable surface area of the nanocables and the thinner layers. The power collected in a given area can be several orders of magnitude higher than that of a conventional planar photovoltaic cell.

Other applications include diodes, transistors, and logical gates. Nanocable transistors, and particularly MOSFETs, can be formed in silicon chips, for example, by first etching dead-end pores in a silicon substrate in accordance with the procedures described above, then lining the pores with nanotubes of a low-reactivity metal such as gold, depositing a layer of an n-type semiconductor over the nanotube surfaces, then a layer of a p-type semiconductor over the n-type semiconductor surfaces, and finally depositing further n-type semiconductor to fill the cores of the nanotubes. At the openings of the pores, the outer gold shell of each nanocable is connected to a voltage source, the core is connected to a voltage drain, and the intermediate shell of n-type semiconductor is connected to serve as a gate. The connections are planar layers over the flat exposed surface of the substrate, the layers serving as leads and adjacent layers being separated by intervening silica layers. The result of this procedure is an array of transistors in the form of nanoplugs embedded in the silicon substrate. While lithography may be necessary in the formation of the surface connections at the exposed ends of the plugs, the plugs themselves are formed without the use of lithography, and are thereby not subject to the size limitations that lithography imposes. The transistors can have widths within the ranges cited above, i.e., with diameters of as low as 5 mm or preferably within the range of about 10 nm to about 50 nm.

Nanocables are also useful in nano-electro-mechanical systems (NEMS), where nanocables can be used for a piezoelectric effect. These applications will suggest still further applications to those skilled in the art. The contents of all publications cited in this specification are incorporated herein by reference for all purposes legally capable of being served thereby.

The following examples are offered for purposes of illustration and are not intended to impose limits on the scope of this invention.

### EXAMPLE 1

This example illustrates the preparation of nanocables within the scope of this invention. The dissimilar materials in these particular nanocables are gold and tellurium.

Polycarbonate track-etched membranes were obtained from Poretics, Inc., with hydraulic pore diameters of approximately 104 nm, a pore density of approximately 6 pores per square micron, and a membrane thickness of 6 microns. Nanotubes were formed within the pores of the membrane by electroless deposition of metallic gold on the inner surfaces of the pores. This was done by first sensitizing the pore surfaces with Sn⁺², then treating the sensitized surfaces with Ag⁺², and finally depositing metallic gold from an aqueous solution of Na₃Au(SO₃)₂ (0.0079 M), Na₂SO₃ (0.127 M), and formaldehyde (0.625 M). Deposition was performed at pH 10 and 0.5° C. for approximately 4 hours, resulting in a reduction in the hydraulic pore size to approximately 35 nm. The resulting nanotubes thus had a wall thickness of approximately 35 nm. The nanotube-containing membranes were then immersed in 25% HNO₃ for twelve hours. In addition to removing all residual Sn and Ag, this left a small annular gap between the nanotubes and the pore walls.

An electrochemical cell for depositing Te on the inner surfaces of the gold nanotubes was then configured with the gold nanotubes as the working electrode, platinum wire as the counter electrode, and Ag/AgCl 3M as a reference electrode. The nanotube-containing membrane and electrodes were immersed in an electrolyte solution containing TeO₂ (0.1 mM), CdSO₄ (IMM), and H₂SO₄ (50 mM), and a potential of −62 mV was applied over 8 hours. The membrane was then dissolved in dichloromethane to release the nanocables.

To enhance visualization of the different layers of the nanocables, the gold was partially removed from the nanocables by etching with potassium iodide. Images were then taken using a Philips CM 12 Transmission Electron Microscope, and a scanning image was taken using a Technia 20 Scanning Transmission Electron Microscope at 100 kV equipped with a Galten electron energy loss spectrum detector for chemical analysis of the scanning image. The results indicated that the nanocables had a core of tellurium, a shell of gold, and a relatively thin outer shell of tellurium.

### EXAMPLE 2

This prophetic example illustrates another procedure by which nanocables within the scope of this invention can be prepared. The dissimilar materials used in this procedure are again gold and tellurium.

Nanotubes of Au (111) are formed within the pores of a nanoporous membrane by the method described in Example 1 above. An electrochemical cell is then configured with the gold nanotubes as the working electrode, platinum wire as the counter electrode, and a standard hydrogen electrode (SHE) as the reference electrode. Tellurium deposition on the Au(111) is begun at a potential E=0.35 V from a solution of 0.05 M H₂SO₄ and 0.1 mM TeO₂, in a (√3×√3)R30° structure with a coverage of θ=1/3 monolayer. The Te layer continues to grow as the potential shifts toward the Nernst potential. This results in bulk deposition of Te in a sequence of several structures due to the misfit between the lattice parameters of Te and Au and to the slow surface diffusion of Te on Au.

When tellurium deposition on the Au(111) is begun at a potential E=0.25 V vs. SHE, the Te grows through a sequence of structures up to 15 monolayers, as follows: (3×3) with θ=4/9 monolayer, (3×(3√3/2)−Te and c(3×(3√3/2)−Te. At greater than 15 monolayers, the Te deposition takes the form of Te(1010)//Au(111). This sequence of layers can be avoided or suppressed by forming the Te layer by underpotential deposition and then depositing a layer of another metal, also by underpotential deposition, over the Te layer.

### EXAMPLE 3

This prophetic example illustrates the deposition of cadmium over gold in accordance with this invention.

As described in Example 2, nanotubes of Au (111) formed within the pores of a nanoporous membrane are used as the working electrode in an electrochemical cell with platinum wire as the counter electrode, and a standard hydrogen electrode (SHE) as the reference electrode. Cadmium deposition on the Au (111) from a solution of 0.05 M H₂SO₄ and 1 mM CdSO₄ begins with a c(4×√3)−Cd (θ=3/8 monolayer) layer at E=0 V while bulk deposition occurs at E==0.49 V. Alloying (inter-diffusion between Cd and Au) occurs at the Au—Cd interface, but can be avoided or suppressed by limiting the deposition of Cd to underpotential deposition conditions and depositing another metal, such as Te, by underpotential deposition over the Cd.

### EXAMPLE 4

This prophetic example illustrates the deposition of both tellurium and cadmium over gold similar in an electrochemical atomic layer epitaxy (ECALE) process within the present invention.

Using a solution that contains both Te and Cd in the same type of cell described in the preceding examples, the potential can be switched back and forth between an underpotential deposition value for one metal and an underpotential deposition value for the other metal, thereby depositing only one monolayer of each at a time. In the case of tellurium and cadmium, the potential can be switched between E=0.35 V for Te and E=0 V for Cd.

### EXAMPLE 5

This prophetic example again illustrates the deposition of both tellurium and cadmium over gold in an electrochemical atomic layer epitaxy (ECALE) process within the present invention. Unlike the process of Example 4, however, the tellurium and gold are used in separate solutions.

Using separate solutions of Te without Cd and Cd without Te, in the same type of cell described in the preceding examples, a first layer is deposited from the Te-only solution by underpotential deposition at the potential indicated in Example 4 (E=0.535 V). The Te-only solution is then removed and replaced with the Cd-only solution to deposit a second layer at the potential indicated in Example 4 (E=0 V). The Te-only solution is then reapplied and the process is repeated until a desired thickness or number of layers is achieved.

The foregoing description is intended primarily as illustration. Further variations, configurations, materials, and applications that utilize the concepts and discoveries of this invention will be apparent to those skilled in the art.

What is claimed is:

1. A method for manufacturing nanocables, said method comprising:
(a) in a form with a plurality of tubular passages therein having diameters of about 200 nm or less, coating the inner surfaces of said passages with a first solid to form a nanotube within each said passage; and
(b) with said nanotubes connected as electrodes, electrochemically depositing a second solid over each of said nanotubes by underpotential deposition to radially grow a layer of said second solid to a selected thickness over each of said nanotubes.

2. The method of claim 1 wherein each tubular passage is open at both ends.

3. The method of claim 1 wherein each tubular passage is closed at one end.

4. The method of claim 1 wherein each tubular passage has a central axis, said method further comprises separating said nanotubes from said form after (b), and said radial growth of (b) is inward toward said axis.

5. The method of claim 1 wherein each nanotube has an outer surface, said method further comprises separating said nanotubes from said form before (b), and said radial growth is outward from said outer surface.

6. The method of claim 1 wherein each nanotube has an outer surface and an inner surface, said method further comprises separating said nanotubes from said form before (b), and said radial growth is both inward from said inner surface and outward from said outer surface.

7. The method of claim 1 further comprising depositing at least one additional layer of solid over said layer of said second solid.

8. The method of claim 1 wherein said first and second solids are electrical conductors.

9. The method of claim 1 wherein said first and second solids are semiconductors.

10. The method of claim 1 wherein one of said first and second solids is a semiconductor and the other is an electrical conductor.

11. The method of claim 1 wherein one of said first and second solids is a semiconductor and the other is an electrical insulator.

12. The method of claim 1 wherein one of said first and second solids is an electrical insulator and the other is an electrical conductor.

13. The method of claim 1 wherein said first and second solids are metals and said first solid is a metal that is substantially less reactive with other elements than said second solid.

14. The method of claim 1 wherein said first solid is a member selected from the group consisting of copper, silver, gold, nickel, palladium, and platinum, and said second solid is a member selected from the group consisting of sulfur, selenium, tellurium, polonium, phosphorus, arsenic, antimony, bismuth, carbon, silicon, germanium, tin, lead, aluminum, gallium, indium, thallium, zinc, cadmium, mercury, and compounds and alloys of these elements.

15. The method of claim 1 wherein said first solid is a member selected from the group consisting of gold and silver and said second solid is a member selected from the group consisting of tellurium, cadmium, cadmium telluride, zinc sulfide, and cadmium sulfide.

16. The method of claim 1 wherein (a) is performed by electroless deposition.

17. The method of claim 1 wherein said tubular passages have diameters within the range of from about 5 nm to about 200 nm.

18. The method of claim 1 wherein said tubular passages have diameters within the range of from about 30 nm to about 150 nm.

19. The method of claim 1 wherein each said nanotube has a tube wall thickness of from about 10 nm to about 100 nm.

20. The method of claim 1 wherein each said nanotube has a tube wall thickness of from about 30 nm to about 150 nm.

21. The method of claim 1 wherein (b) is performed at a potential whose value is equal to or less than two-thirds the potential at which bulk deposition of said second solid occurs.

22. The method of claim 1 wherein (b) is performed at a potential whose value is equal to or less than one-third the potential at which bulk deposition of said second solid occurs.

23. The method of claim 1 wherein said form is a track-etched polymer nanoporous membrane.

24. The method of claim 23 wherein said nanoporous membrane is track-etched polycarbonate.

25. The method of claim 1 further comprising doping one of said first and second solids with a n-type or p-type dopant.

26. A nanocable manufactured by a process comprising:
(a) coating the inner surface of a tubular passage in a form having a plurality of said passages therein with a first solid to form a nanotube within said passage, said tubular passage having a diameter of about 200 nm or less; and
(b) with said nanotube connected as an electrode, electrochemically depositing a second solid over said nanotube by underpotential deposition to radially grow a layer of said second solid to a selected thickness over said nanotube.

27. The nanocable of claim 26 wherein said tubular passage is open at both ends.

28. The nanocable of claim 26 wherein said tubular passage is closed at one end.

29. The nanocable of claim 26 wherein said tubular passage has a central axis, said method further comprises separating said nanotubes from said form after (b), and said radial growth of (b) is inward toward said axis.

30. The nanocable of claim 26 wherein said nanotube has an outer surface, said method further comprises separating said nanotubes from said form before (b), and said radial growth is outward from said outer surface.

31. The nanocable of claim 26 wherein said tubular passage has a central axis and said nanocable comprises a plurality of layers radially disposed about said central axis, at least one of said layers formed by (b).

32. The nanocable of claim 26 wherein said first and second solids are electrical conductors.

33. The nanocable of claim 26 wherein said first and second solids are semiconductors.

34. The nanocable of claim 26 wherein one of said first and second solids is a semiconductor and the other is an electrical conductor.

35. The nanocable of claim 26 wherein one of said first and second solids is a semiconductor and the other is an electrical insulator.

36. The nanocable of claim 26 wherein one of said first and second solids is an electrical insulator and the other is an electrical conductor.

37. The nanocable of claim 26 wherein said first and second solids are metals and said first solid is a metal that is substantially less reactive with other elements than said second solid.

38. The nanocable of claim 26 wherein said first solid is a member selected from the group consisting of gold, silver, platinum, palladium, and copper, and said second solid is a member selected from the group consisting of tellurium, cadmium, cadmium telluride, zinc sulfide, silicon, germanium, selenium, cadmium selenide, and cadmium sulfide.

39. The nanocable of claim 26 wherein said first solid is a member selected from the group consisting of copper, silver, gold, nickel, palladium, and platinum, and said second solid is a member selected from the group consisting of sulfur, selenium, tellurium, polonium, phosphorus, arsenic, antimony, bismuth, carbon, silicon, germanium, tin, lead, aluminum, gallium, indium, thallium, zinc, cadmium, mercury, and compounds and alloys of these elements.

40. The nanocable of claim 26 wherein said nanotube has an outer diameter of from about 5 nm to about 200 nm and a wall thickness of from about 10 nm to about 100 nm.

41. The nanocable of claim 26 wherein said nanotube has an outer diameter of from about 30 nm to about 150 nm and a wall thickness of from about 30 nm to about 150 nm.

42. A silicon substrate-embedded transistor manufactured by a process comprising:
(a) coating the inner surface of a closed-end well in a silicon substrate with a first solid to form a nanotube within said well, said well having a diameter of about 200 nm or less;
(b) with said nanotube connected as an electrode, electrochemically depositing a second solid over said nanotube by underpotential deposition to radially grow a layer of said second solid to a selected thickness over said nanotube; and
(c) repeating step (b) a sufficient number of times to form a multi-layered plug within said well, using different materials for adjacent layers which together are capable of functioning as a transistor when connected to electrical leads, and electrically connecting said layers to said electrical leads at the mouth of said well.

43. The transistor of claim 42 wherein said well diameter is from about 5 nm to about 200 nm.

44. The transistor of claim 42 wherein said well diameter is from about 10 nm to about 50 nm.
